(19) United States
(12) Patent Application Publication
(10) Pub. No.: US 2020/0368903 A1
(43) Pub. Date: Nov. 26, 2020

(54) ARTICULATED ROBOTIC DEVICE AND ARTICULATED ROBOT CONTROL METHOD

(71) Applicant: KYOCERA Document Solutions Inc., Osaka (JP)

(72) Inventor: Teruyuki MIYAMOTO, Osaka-shi (JP)

(73) Assignee: KYOCERA Document Solutions Inc., Osaka (JP)

(21) Appl. No.: 16/874,459

(22) Filed: May 14, 2020

(30) Foreign Application Priority Data
May 22, 2019 (JP) 2019-096335

(51) Int. Cl. B25J 9/16

(52) U.S. Cl. CPC B25J 9/1664

(57) ABSTRACT

An articulated robotic device includes a robotic hand device, an end effector device, an output section, and a controller. The robotic hand device includes arms coupled to each other. The end effector device is connected to the robotic hand device. The output section outputs a signal indicating a magnitude of an external force applied to the end effector device and a direction of the external force. The controller controls movement of the robotic hand device according to the magnitude and the direction of the external force. Moreover, the controller performs posture fixing control by controlling the movement of the robotic hand device so that a posture of the end effector device is fixed in a specific posture during direct teaching of the articulated robotic device by an operator.

### INCORPORATION BY REFERENCE

The present application claims priority under 35 U.S.C. § 119 to Japanese Patent Application No. 2019-096335, filed on May 22, 2019, The contents of this application are incorporated herein by reference in their entirety.

### BACKGROUND

The present disclosure relates to an articulated robotic device and an articulated robot control method.

There is a known articulated robotic device equipped with an end effector device and a robotic hand device that drives the end effector device. The robotic hand device includes arms coupled to each other. The end effector device is replaceable and connected to a distal end of the robotic hand device.

Conventionally, an operator directly moves the end effector device to set a position and a posture to be taken by the articulated robot, which is known as direct teaching.

An articulated robotic device includes six joint rotational axes from a first axis to a six axis. In the direct teaching of the articulated robotic device, brakes applied to the six joint rotational axes are released one by one in a predetermined order at regular time intervals. This enables the operator to freely rotate each joint rotational axis with the brakes released only for a certain time.

### SUMMARY

An articulated robotic device according to an aspect of the present disclosure includes a robotic hand device, an end effector device, an output section, and a controller. The robotic hand device includes arms coupled to each other. The end effector device is connected to the robotic hand device. The output section outputs a signal indicating a magnitude of an external force applied to the end effector device and a direction of the external force. The controller controls movement of the robotic hand device according to the magnitude and the direction of the external force. Moreover, the controller performs posture fixing control by controlling the movement of the robotic hand device so that a posture of the end effector device is fixed in a specific posture during direct teaching of the articulated robotic device by an operator.

An articulated robot control method of an aspect of the present disclosure is an articulated robot control method by an articulated robotic device. The articulated robotic device includes a robotic hand device includes arms coupled to each other, and an end effector device connected to the robotic hand device. The articulated robot control method includes outputting a signal indicating a magnitude of an external force applied to the end effector device and a direction of the external force, controlling movement of the robotic hand device according to the magnitude and the direction of the external force, and performing posture fixing control by controlling the movement of the robotic hand device so that a posture of the end effector device is fixed in a specific posture during direct teaching of the articulated robotic device by an operator.

### BRIEF DESCRIPTION OF THE DRAWINGS

FIG. 1 is a perspective view of an appearance example of an articulated robotic device according to an embodiment of the present disclosure.

FIG. 2 is a block diagram depicting an example of a circuit configuration of the articulated robotic device.

FIG. 3 is a flowchart depicting an example of an operation of a controller.

FIG. 4 is a flowchart following the flowchart in FIG. 3.

FIG. 5 is a flowchart following the flowchart in FIG. 4.

FIG. 6 is a flowchart depicting an example of an operation of the controller for teaching assistance.

### DETAILED DESCRIPTION

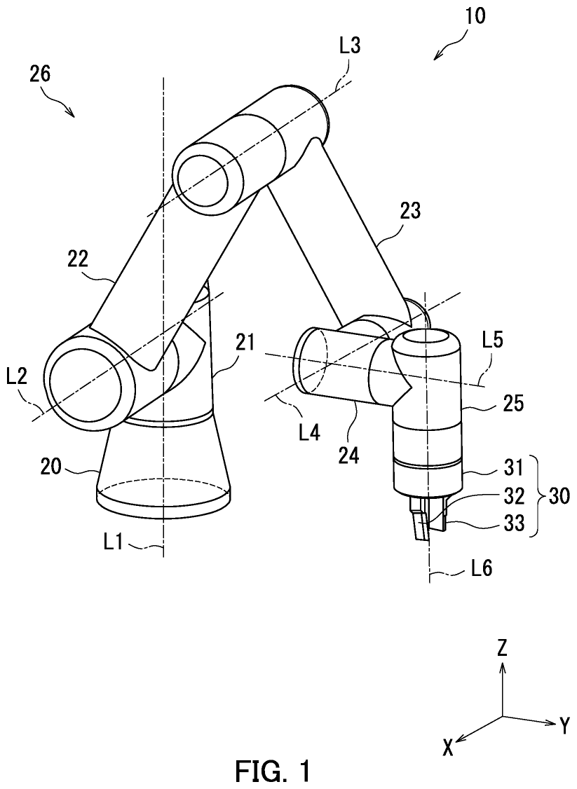

An embodiment of the present disclosure will hereinafter be described with reference to FIGS. 1 to 6. Elements that are the same or equivalent are labelled with the same reference signs in the drawings and description thereof is not repeated.

An articulated robotic device 10 according to the embodiment will first be described with reference to FIG. 1. FIG. 1 is a perspective view of an appearance example of the articulated robotic device 10. In FIG. 1, a positive side of an X-axis and a positive side of a Y-axis are directions intersecting each other in a horizontal plane, and a positive side of a Z-axis is a vertical upward direction.

As illustrated in FIG. 1, the articulated robotic device 10 includes a base 20, a robotic hand device 26, and an end effector device 30. The robotic hand device 26 is mounted on the base 20. The end effector device 30 is replaceable and connected to a distal end of the robotic hand device 26. The robotic hand device 26 drives the end effector device 30. Note that end effector may hereinafter also be referred to as “EE”.

The robotic hand device 26 includes arms coupled to each other. Specifically, the robotic hand device 26 includes a shoulder section 21, a lower arm 22, a first upper arm 23, a second upper arm 24, and a wrist section 25.

The shoulder section 21 is coupled to the base 20 and allowed to pivot around a first axis L1 extending in a Z-axis direction as a center.

The lower arm 22 is coupled to the shoulder section 21 and allowed to pivot around a second axis L2 extending in a direction intersecting the first axis L1 as a center to move up and down.

The first upper arm 23 is coupled to a distal end of the lower arm 22 and allowed to pivot around a third axis L3 extending parallel to the second axis L2 as a center to move up and down.

The second upper arm 24 is coupled to a distal end of the first upper arm 23 and allowed to twist and turn around a fourth axis L4 extending parallel to the third axis L3 as a center.

The wrist section 25 is coupled to a distal end of the second upper arm 24 and allowed to pivot around a fifth axis L5 extending in a direction intersecting the fourth axis L4 as a center to move up and down.

The EE device 30 is configured as a gripping mechanism that includes a housing 31, a first finger 32, and a second finger 33. The housing 31 is connected to a distal end of the wrist section 25 and allowed to twist and turn around a sixth axis L6 extending in a direction intersecting the fifth axis L5 as a center. The first and second fingers 32 and 33 protrude from an opening provided in the housing 31.

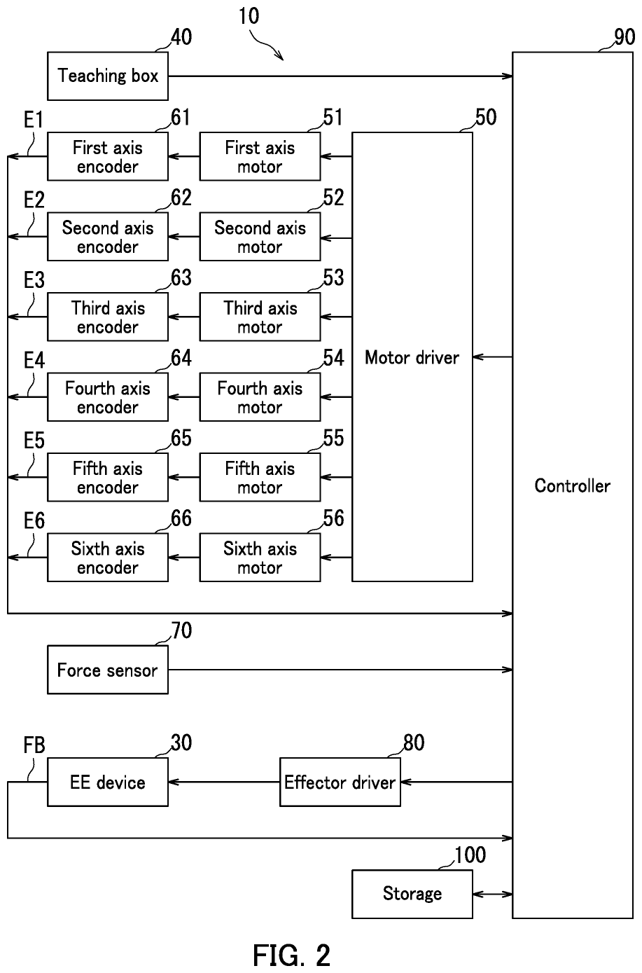

A circuit configuration of the articulated robotic device 10 will next be described with reference to FIGS. 1 and 2. FIG. 2 is a block diagram depicting an example of the circuit configuration of the articulated robotic device 10.

As illustrated in FIG. 2, the articulated robotic device 10 includes a motor driver 50, a first axis motor 51, a second axis motor 52, a third axis motor 53, a fourth axis motor 54, a fifth axis motor 55, and a sixth axis motor 56. The motor driver 50 drives the first to sixth axis motors 51 to 56. The first axis motor 51 rotates the shoulder section 21 around the first axis L1. The second axis motor 52 rotates the lower arm 22 around the second axis L2. The third axis motor 53 rotates the first upper arm 23 around the third axis L3. The fourth axis motor 54 rotates the second upper arm 24 around the fourth axis L4. The fifth axis motor 55 rotates the wrist section 25 around the fifth axis L5. The sixth axis motor 56 rotates the EE device 30 around the sixth axis L6.

The articulated robotic device 10 further includes a first axis encoder 61, a second axis encoder 62, a third axis encoder 63, a fourth axis encoder 64, a fifth axis encoder 65, and a sixth axis encoder 66. The first axis encoder 61 detects rotation of the first axis motor 51 to output a first encoder signal E1. The second axis encoder 62 detects rotation of the second axis motor 52 to output a second encoder signal E2. The third axis encoder 63 detects rotation of the third axis motor 53 to output a third encoder signal E3. The fourth axis encoder 64 detects rotation of the fourth axis motor 54 to output a fourth encoder signal E4. The fifth axis encoder 65 detects rotation of the fifth axis motor 55 to output a fifth encoder signal E5. The sixth axis encoder 66 detects rotation of the sixth axis motor 56 to output a sixth encoder signal E6.

The articulated robotic device 10 further includes a teaching box 40, a force sensor 70, an effector driver 80, a controller 90, and storage 100.

The controller 90 provides a control signal to the motor driver 50 to control movement of the robotic hand device 26. The first to sixth encoder signals E1 to E6 are fed back to the controller 90. The first to sixth encoder signals E1 to E6 indicate the movement of the robotic hand device 26.

The teaching box 40 supplies the controller 90 with a signal indicating an operator instruction in teaching. For example, the teaching box 40 supplies the controller 90 with a signal indicating an instruction to start direct teaching and a signal indicating an instruction to end the direct teaching. The teaching box 40 also supplies the controller 90 with a signal indicating an instruction to start posture fixing control of the EE device 30 and a signal indicating an instruction to end the posture fixing control of the EE device 30.

The posture fixing control of the EE device 30 means control of the movement of the robotic hand device 26 so that a posture of the EE device 30 is fixed in a specific posture. The specific posture includes a specific orientation of the sixth axis L6 that is a rotational axis of the EE device 30. In addition, the specific posture further includes a specific rotational position of the EE device 30 around the sixth axis L6.

In addition to the signal indicating the instruction to start the posture fixing control of the EE device 30, the teaching box 40 supplies the controller 90 with a signal indicating a specific posture of the EE device 30, obtained by selecting any one of postures including a first posture, a second posture, a third posture, and a fourth posture.

In the case where the first posture is selected, the movement of the robotic hand device 26 is controlled so that the EE device 30 is fixed with an orientation of the rotational axis thereof facing down in the vertical direction, namely a negative side of the Z-axis. Moreover, in the case where the first posture is selected, a rotational position of the EE device 30 around the rotational axis is controlled so that the EE device 30 is fixed with a gripping direction thereof that is a movement direction of the first and second fingers 32 and 33 being parallel to the X-axis.

In the case where the second posture is selected, the movement of the robotic hand device 26 is controlled so that the EE device 30 is fixed with the orientation of the rotational axis thereof facing the negative side of the Z-axis like the case where the first posture is selected. Note that in the case where the second posture is selected, the rotational position of the EE device 30 around the rotational axis is controlled so that the EE device 30 is fixed with the gripping direction thereof being parallel to the Y-axis.

In the case where the third posture is selected, the movement of the robotic hand device 26 is controlled so that the EE device 30 is fixed with the orientation of the rotational axis thereof facing a direction intersecting the vertical direction such as the positive side of the X-axis. Moreover, in the case where the third posture is selected, the rotational position of the EE device 30 around the rotational axis is controlled so that the EE device 30 is fixed with the gripping direction thereof being parallel to the Z-axis.

In the case where the fourth posture is selected, the movement of the robotic hand device 26 is controlled so that the EE device 30 is fixed with the orientation of the rotational axis thereof facing for example the positive side of the X-axis like the case where the third posture is selected. Note that in the case where the fourth posture is selected, the rotational position of the EE device 30 around the rotational axis is controlled so that the EE device 30 is fixed with the gripping direction thereof being parallel to the Y-axis.

The force sensor 70 is configured as a 6-axis haptic sensor which outputs a signal indicating a magnitude of an external force applied to the EE device 30 by the operator and a direction of the external force. The force sensor 70 is attached between the robotic hand device 26 and the EE device 30. An output signal of the force sensor 70 is supplied to the controller 90. The controller 90 detects the external force applied to the EE device 30 by the operator based on the output signal of the force sensor 70. The force sensor 70 corresponds to one example of an “output section”.

The effector driver 80 controls movement of the first finger 32 and movement of the second finger 33 in the EE device 30. An output signal of a built-in sensor (not shown) in the EE device 30 is supplied as a feedback signal FB to the controller 90.

The controller 90 includes a processor such as a central processing unit (CPU). The storage 100 includes main memory such as semiconductor memory and an auxiliary storage device such as a hard disk drive. The storage 100 stores therein data and a computer program. The processor of the controller 90 executes the computer program stored in the storage 100, thereby controlling each component of the articulated robotic device 10.

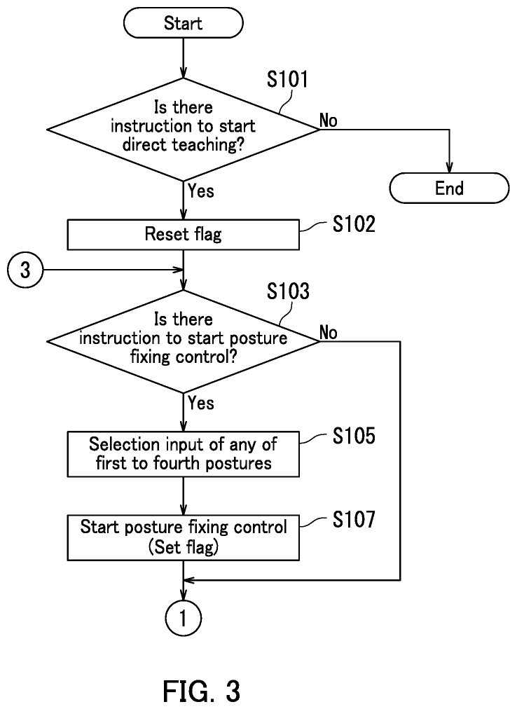

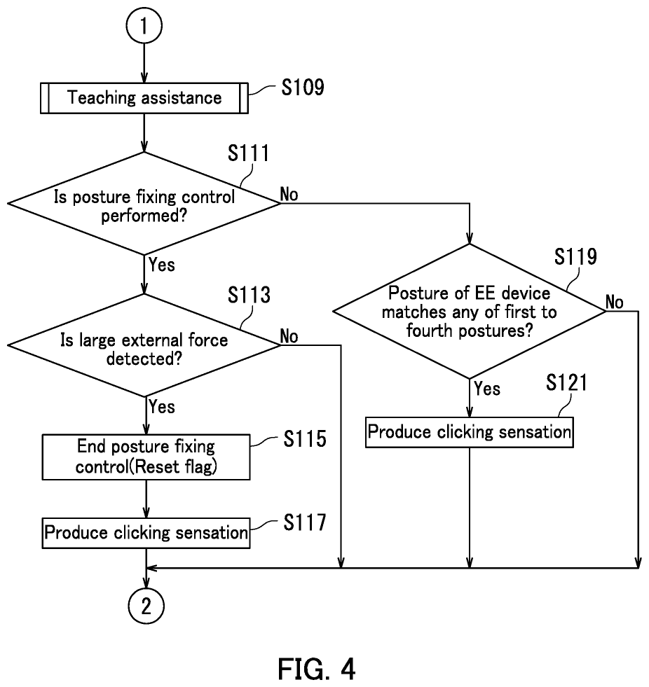

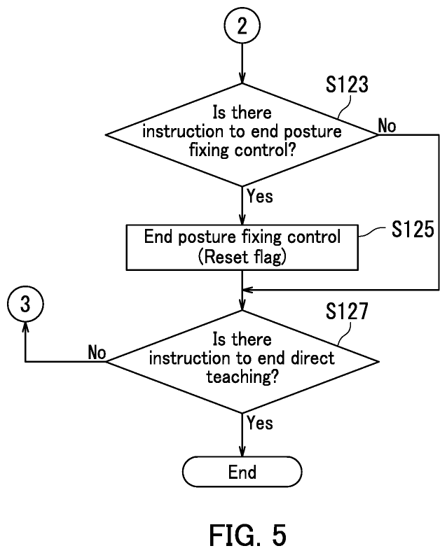

Operation of the controller 90 will next be described with reference to FIGS. 1 to 5. FIG. 3 is a flowchart depicting an example of the operation of the controller 90. FIG. 4 is a flowchart following the flowchart in FIG. 3. FIG. 5 is a flowchart following the flowchart in FIG. 4.

At Step S101: as illustrated in FIG. 3, the controller 90 refers to a signal from the teaching box 40 and determines whether or not an instruction to start direct teaching is provided. When the controller 90 determines that the instruction to start the direct teaching is provided (Yes at Step S101), a process of the controller 90 proceeds to Step S102. When the controller 90 determines that the instruction to start the direct teaching is not provided (No at Step S101), the process of the controller 90 ends.

At Step S102: the controller 90 resets a flag to “0”. Here, the flag indicates a state of the posture fixing control. The flag that is reset to “0” indicates that the posture fixing control is not being performed. The flag that is set to “1” indicates that the posture fixing control is being performed. When Step S102 in the process ends, the process of the controller 90 proceeds to Step S103.

At Step S103: the controller 90 refers to a signal from the teaching box 40 and determines whether or not an instruction to start the posture fixing control is provided. When the controller 90 determines that the instruction to start the posture fixing control is provided (Yes at Step S103), the process of the controller 90 proceeds to Step S105. When the controller 90 determines that the instruction to start the posture fixing control is not provided (No at Step S103), the process of the controller 90 proceeds to Step S109 (see FIG. 4).

At Step S105: the controller 90 receives a signal from the teaching box 40. Here, the signal indicates a specific posture of the EE device 30 in the posture fixing control, obtained by selecting any one of the first to fourth postures, When Step S105 in the process ends, the process of the controller 90 proceeds to Step S107.

At Step S107: the controller 90 sets, to “1”, a flag indicating that the posture fixing control has been started. When Step S105 in the process ends, the process of the controller 90 proceeds to Step S109 (see FIG: 4).

At Step S109: as illustrated in FIG. 4, the controller 90 performs teaching assistant to be described later. The teaching assistance means assisting the operator in the movement of the articulated robotic device 10 by controlling torque generated by each of the first to sixth axis motors 51 to 56.

At Step S111, the controller 90 refers to the flag and determines whether or not the posture fixing control is being performed. When the controller 90 determines that the posture fixing control is being performed (Yes at Step S111), the process of the controller 90 proceeds to Step S113. When the controller 90 determines that the posture fixing control is not being performed (No at Step S111), the process of the controller 90 proceeds to Step S119.

At Step S113: the controller 90 determines whether or not an external force whose magnitude exceeds a predetermined magnitude is detected. When the controller 90 determines that the external force whose magnitude exceeds the predetermined magnitude is detected (Yes at Step S113), the process of the controller 90 proceeds to Step S115. When the controller 90 determines that the external force whose magnitude exceeds the predetermined magnitude is not detected (No at Step S113), the process of the controller 90 proceeds to Step S123 (see FIG. 5).

At Step S115: the controller 90 resets the flag so that the flag indicates that the posture fixing control has ended. When Step S115 in the process ends, the process of the controller 90 proceeds to Step S117.

At Step S117: the controller 90 performs control for producing a clicking sensation to be provided for the operator, which enables the operator to recognize that the posture fixing control has ended. The controller 90 controls the brakes applied to the first axis to sixth axis motors 51 to 56 so that a reaction force increasing or decreasing according to the magnitude of the external force applied to the EE device 30 is generated, thereby realizing a clicking sensation. When Step S117 in the process ends, the process of the controller 90 proceeds to Step S123 (see FIG. 5).

At Step S119: the controller 90 determines whether or not the posture of the EE device 30 matches any one of the first to fourth postures. When the controller 90 determines that the posture of the EE device 30 matches any one of the first to fourth postures (Yes at Step S119), the process of the controller 90 proceeds to Step S121. When the controller 90 determines that the posture of the EE device 30 does not match any one of the first to fourth postures (No at Step S119), the process of the controller 90 proceeds to Step S123 (see FIG. 5).

At Step S121: the controller 90 performs control for producing a clicking sensation to be provided for the operator, which enables the operator to recognize that a specific posture of the EE device 30 has been realized or that the posture of the EE device 30 is returned from a posture different from the specific posture to the specific posture during a time period when the posture fixing control is not performed. The controller 90 controls the brakes applied to the first axis to sixth axis motors 51 to 56 so that a reaction force increasing or decreasing according to the magnitude of the external force applied to the EE device 30 is generated, thereby realizing a clicking sensation. When Step S121 in the process ends, the process of the controller 90 proceeds to Step S123 (see FIG. 5),

At Step S123: as illustrated in FIG. 5, the controller 90 refers to a signal from the teaching box 40 and determines whether or not an instruction to end the posture fixing control is provided. When the controller 90 determines that the instruction to end the posture fixing control is provided (Yes at Step S123), the process of the controller 90 proceeds to Step S125. When the controller 90 determines that the instruction to end the posture fixing control is not provided (No at Step S123), the process of the controller 90 proceeds to Step S127.

At Step S125: the controller 90 resets the flag so that the flag indicates that the posture fixing control has ended. When Step S125 in the process ends, the process of the controller 90 proceeds to Step S127.

At Step S127: the controller 90 refers to a signal from the teaching box 40 and determines whether or not an instruction to end the direct teaching is provided. When the controller 90 determines that the instruction to end the direct teaching is provided (Yes at Step S127), the process of the controller 90 ends. When the controller 90 determines that the instruction to end the direct teaching is not provided (No at Step S127), the process of the controller 90 returns to Step S103 (see FIG. 3).

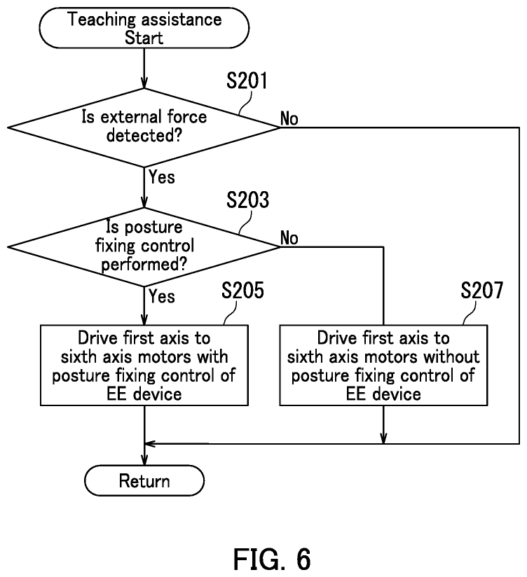

A teaching assistance operation of the controller 90 will next be described with reference to FIGS. 1 to 6. FIG. 6 is a flowchart depicting an example of the operation of the controller 90.

At Step S201: as illustrated in FIG. 6, the controller 90 determines whether or not an external force is detected. When the controller 90 determines that the external force is detected (Yes at Step S201), the process of the controller 90 proceeds to Step S203. When the controller 90 determines that the external force is not detected (No at Step S201), the process returns to the flowchart in FIG. 4 with the teaching assistance not performed.

At Step S203, the controller 90 refers to the flag and determines whether or not the posture fixing control is being performed. When the controller 90 determines that the posture fixing control is being performed (Yes at Step S203), the process of the controller 90 proceeds to Step S205. When the controller 90 determines that the posture fixing control is not being performed (No at Step S203), the process of the controller 90 proceeds to Step S207.

At Step S205: while checking the first to sixth encoder signals E1 to E6, the controller 90 drives the first axis to sixth axis motors 51 to 56 through the motor driver 50 so that the posture of the EE device 30 is fixed in a specific posture. Moreover, the controller 90 drives the first axis to sixth axis motors 51 to 56 so that an external force is almost canceled according to the magnitude and the direction of the external force detected based on the output signal of the force sensor 70. Force control performed in this way realizes teaching assistance to the operator. When Step S205 in the process ends, the process returns to the flowchart in FIG. 4.

At Step S207: while checking the first to sixth encoder signals E1 to E6, the controller 90 drives the first axis to sixth axis motors 51 to 56 through the motor driver 50. Note that the posture fixing control of the EE device 30 is nor performed. In addition, the controller 90 drives the first axis to sixth axis motors 51 to 56 so that an external force is almost canceled according to the magnitude and the direction of the external force detected based on the output signal of the force sensor 70. Force control performed in this way realizes the teaching assistance to the operator. When Step S207 in the process ends, the process returns to the flowchart in FIG. 4.

The embodiment provides the articulated robotic device 10 capable of improving efficiency of the direct teaching.

The description of the above-described embodiment may include various technically preferable limitations in order to describe a preferred embodiment in the present disclosure. However, the technical scope of the present disclosure is not limited to the embodiment unless otherwise specified by descriptions limiting the present disclosure. That is, the constituent elements in the above-described embodiment can be appropriately replaced with existing constituent elements or the like and various variations are possible, including combinations with other existing constituent elements. The descriptions of the embodiment are not intended to limit content of the disclosure described in the scope of claims.

For example, although the force sensor 70 outputs a signal indicating the magnitude and the direction of the external force as illustrated in FIG. 2 in the embodiment, the present disclosure is not limited to this. For example, the motor driver 50 may output a signal indicating a magnitude of an electric current flowing through the first axis to sixth axis motors 51 to 56 as a signal indicating a magnitude and a direction of an external force. The first axis to sixth axis motors 51 to 56 may be provided with their respective current sensors that output respective signals representing the magnitude of electric currents flowing through the first axis to sixth axis motors 51 to 56.

Although a specific posture of the EE device 30 in the posture fixing control is obtained by selecting any one of the first to fourth postures as illustrated in FIG. 3 in the embodiment, the present disclosure is not limited to this. The specific posture of the EE device 30 in the posture fixing control may be arbitrary selected.

Although the controller 90 performs control for producing a clicking sensation to be provided for an operator when a posture of the EE device 30 matches any one of the first to fourth postures during a time period when the posture fixing control is not performed as illustrated in FIG. 3 in the embodiment, the present disclosure is not limited to this. Regarding for example the first posture, the controller 90 may perform control for producing a first clicking sensation when the orientation of the rotational axis of the EE device 30 matches down in the vertical direction, and for producing a second clicking sensation when the rotational position of the EE device 30 around the rotational axis is parallel to the X-axis. This is equally applicable to the second to fourth postures.

What is claimed is:

1. An articulated robotic device, comprising:
a robotic hand device including arms coupled to each other;
an end effector device connected to the robotic hand device;
an output section configured to output a signal indicating a magnitude of an external force applied to the end effector device and a direction of the external force; and
a controller configured to control movement of the robotic hand device according to the magnitude and the direction of the external force, wherein
the controller performs posture fixing control by controlling the movement of the robotic hand device so that a posture of the end effector device is fixed in a specific posture during direct teaching of the articulated robotic device by an operator.

2. The articulated robotic device according to claim 1, wherein
the specific posture includes a specific orientation of a rotational axis of the end effector device.

3. The articulated robotic device according to claim 2, wherein
the specific posture further includes a specific rotational position of the end effector device around the rotational axis.

4. The articulated robotic device according to claim 1, wherein
the controller performs control for producing a clicking sensation to be provided for the operator when the posture of the end effector device matches the specific posture during a time period when the posture fixing control is not performed.

5. The articulated robotic device according to claim 4, wherein
the controller realizes the clicking sensation by controlling brakes applied to a motor configured to drive the arms so that a reaction force increasing or decreasing according to the magnitude of the external force is generated.

6. The articulated robotic device according to claim 1, wherein
the controller ends the posture fixing control when the magnitude of the external force exceeds a predetermined magnitude.

7. The articulated robotic device according to claim 6, wherein
the controller performs control for producing the clicking sensation to be provided for the operator when the posture fixing control ends.

8. The articulated robotic device according to claim 7, wherein
the controller realizes the clicking sensation by controlling brakes applied to a motor configured to drive the arms so that a reaction force increasing or decreasing according to the magnitude of the external force is generated.

9. An articulated robot control method by an articulated robotic device, the articulated robotic device including a robotic hand device including arms coupled to each other, and an end effector device connected to the robotic hand device, wherein
the articulated robot control method comprises:
outputting a signal indicating a magnitude of an external force applied to the end effector device and a direction of the external force;
controlling movement of the robotic hand device according to the magnitude and the direction of the external force; and
performing posture fixing control by controlling the movement of the robotic hand device so that a posture of the end effector device is fixed in a specific posture during direct teaching of the articulated robotic device by an operator.

10. The articulated robot control method according to claim 9, wherein
the specific posture includes a specific orientation of a rotational axis of the end effector device.

11. The articulated robot control method according to claim 10, wherein
the specific posture further includes a specific rotational position of the end effector device around the rotational axis.

12. The articulated robot control method according to claim 9, further comprising
performing control for producing a clicking sensation to be provided for the operator when the posture of the end effector device matches the specific posture during a time period when the posture fixing control is not performed.

13. The articulated robot control method according to claim 12, wherein
the clicking sensation is realized by controlling brakes applied to a motor configured to drive the arms so that a reaction force increasing or decreasing according to the magnitude of the external force is generated.

14. The articulated robot control method according to claim 9, further comprising
ending the posture fixing control when the magnitude of the external force exceeds a predetermined magnitude.

15. The articulated robot control method according to claim 14, further comprising
performing control for producing the clicking sensation to be provided for the operator when the posture fixing control ends.

16. The articulated robot control method according to claim 15, wherein
the clicking sensation is realized by controlling brakes applied to a motor configured to drive the arms so that a reaction force increasing or decreasing according to the magnitude of the external force is generated.
